(19) United States
(12) Patent Application Publication
(10) Pub. No.: US 2023/0031992 A1
(43) Pub. Date: Feb. 2, 2023

(54) SYSTEMS AND METHODS FOR AUTOMATIC PRINTING OF SHIPPING LABELS FOR ORDERS BYPASSING STOWAGE IN A WAREHOUSE

(71) Applicant: SHOPIFY INC., Ottawa (CA)

(72) Inventors: Diana Rebeca BIRSAN, Ottawa (CA); Philibert DUGAS, Terrebonne (CA); Carmen SPITZ, Montreal (CA)

(21) Appl. No.: 17/389,068

(22) Filed: Jul. 29, 2021

(51) Int. Cl. G06Q 10/08; G06F 16/903; G05B 19/4155

(52) U.S. Cl. CPC G06Q 10/087; G05B 19/4155; G06F 16/90335; G05B 2219/50391

(57) ABSTRACT

Methods and systems are disclosed for rerouting a received batch of a particular product. It is determined that a quantity of the particular product in the received batch is less than or equal to a quantity of the particular product required to fulfill a plurality of orders. The received batch is rerouted to omit shelving and storing the received batch. Instructions are communicated to a label printer to cause the label printer to print a set of shipping labels for application to the products of the received batch. Shipment of the labeled products fulfills a fulfillable number of orders awaiting fulfilment, where a total quantity of the particular product required to fulfill the fulfillable number of orders is equal to the quantity of the particular product in the received batch.

### FIELD

The present disclosure relates to systems and methods for automatic printing of corresponding shipping labels for products and, more particularly, to the automatic printing of shipping labels responsive to dynamic rerouting of products at warehouse induction to fulfill an order without stowing those products in the warehouse. In particular, the present disclosure relates to systems and methods for rerouting products from induct directly to shipping, with shipping labels being automatically printed to match the received batch of products, bypassing the put-away, storage and picking of the products in the warehouse.

### BACKGROUND

Typically, products in a warehouse (also referred to as a fulfillment center) are managed using a few phases, namely induct, put-away, storage, picking, packing and shipping. Warehouse management software (WMS) is typically used to track the product through these phases. These phases may be referred to altogether as the “lifecycle” of a product in a warehouse. Although some warehouse processes may involve a greater or fewer number of warehouse phases, or may refer to these phases using other terms, these phases are generally found in some form in most conventional warehouse processes.

Operations of the WMS involve tracking and managing movement of products through these warehouse phases. It is important that every unit of product is closely tracked throughout these warehouse phases, to maximize customer satisfaction and minimize warehouse costs (among other concerns). In a typical warehouse, there may be thousands or tens of thousands of different products to track and manage. Considerable computing resources (e.g., processing power, network communication resources and memory resources) are required to generate and manage this data.

It would be desirable to provide a way to improve the efficiency of the movement of products through a warehouse, and improve the performance of warehouse management software.

### SUMMARY

In various examples, the present disclosure describes systems and methods that enable more efficient use of warehouse resources, including human resources (e.g., warehouse workers), storage resources (e.g., shelf space), and computer resources (e.g., processing power, network communication resources and memory resources). In examples where autonomous vehicles (e.g., including semi-autonomous or fully-autonomous mobile robots or carts) are used in a warehouse, such autonomous vehicles may be included in the warehouse resources. Examples of the present disclosure may enable more efficient use of computer resources for managing such autonomous vehicles, as well as more efficient use of resources by the autonomous vehicles themselves (e.g., reducing use of battery power, reducing use of memory resources, reducing general wear-and-tear, etc.).

The disclosed systems and methods address the problem of inflexibility in the warehouse management process. Conventionally, the tracking and movement of products in a warehouse involves the same warehouse phases regardless of whether the received products are immediately required to fulfill orders or not. This inflexibility may be intentional in conventional warehouse processes, for reasons of quality control, consistency, manageability and simplifying personnel training (among other reasons). However, this inflexibility leads to inefficient use of warehouse resources, including inefficient use of human resources, inefficient use of storage resources, and inefficient use of computer resources (as well as inefficient use of autonomous vehicle resources, if applicable). [0004] The examples of the present disclosure enable a computing system of the warehouse (e.g., a computer executing WMS) to use warehouse resources more efficiently in the unique scenario where a received batch of a particular product is determined to be all required to fulfill orders for the particular product awaiting fulfillment (e.g., preorders and/or backorders for the particular product). By automatically rerouting a batch of products from induct directly to shipping, or directly to packing, the put-away, storage and picking phases are bypassed and the WMS does not need to track movement of the products through these phases. In some examples, the inventory data maintained by the WMS may not even be updated to track the received batch of products. As a result, significant savings in computer resources may be achieved.

In some examples, the present disclosure describes a system. The system includes a processing unit configured to execute instructions to cause the system to: receive, from a scanner device, an identification of a received batch of a particular product, the identification including an identification of the particular product in the received batch and a quantity thereof in the received batch; query a database of orders to identify a plurality of orders for the particular product awaiting fulfillment; determine that the quantity of the particular product in the received batch is less than or equal to a quantity of the particular product required to fulfill the plurality of orders for the particular product awaiting fulfillment. The method also includes: responsive to the determination that the quantity of the particular product in the received batch is less than or equal to the quantity required to fulfill the plurality of orders: reroute the received batch to omit shelving and storing the received batch; and communicate instructions to a label printer to cause the label printer to print a set of shipping labels for application to the products of the received batch, wherein shipment of the labeled products fulfills a fulfillable number of the plurality of orders for the particular product awaiting fulfillment, and wherein a total quantity of the particular product required to fulfill the fulfillable number of the plurality of orders is equal to the quantity of the particular product in the received batch.

In any of the preceding examples, the processing unit may be further configured to execute instructions to cause the system to: responsive to the determination that the quantity of the particular product in the received batch is less than or equal to the quantity required to fulfill the plurality of orders, generate routing instructions to cause the received batch to be routed directly to a packing station or a shipping station.

In any of the preceding examples, the processing unit may be further configured to execute instructions to cause the system to: communicate the routing instructions to an autonomous mobile robot assigned to convey the received batch, to change a target destination of the autonomous mobile robot to be the packing station or the shipping station.

In any of the preceding examples, the processing unit may be further configured to execute instructions to cause the system to: responsive to the determination that the quantity of the particular product in the received batch is less than or equal to the quantity required to fulfill the plurality of orders, generate routing instructions to cause the received batch to be shipped out directly without being routed to a packing station or a shipping station.

In any of the preceding examples, the processing unit may be further configured to execute instructions to cause the system to: update the order database to indicate that the fulfillable number of the plurality of orders is fulfilled; and an inventory count of the particular product may be unchanged.

In any of the preceding examples, the processing unit may be further configured to execute instructions to cause the system to: identify, from the identification of the received batch, at least two variants of the particular product in the received batch, and determine a respective position of each variant in a defined unpacking sequence for the received batch; determine an order sequence for the fulfillable number of the plurality of orders, based on matching a respective product variant required to fulfill each of the fulfillable number of the plurality of orders with the respective position of each variant in the defined unpacking sequence; and communicate instructions to the label printer to sequentially print the set of labels according to shipping information contained in each order in the order sequence.

In any of the preceding examples, the processing unit may be further configured to execute instructions to cause the system to: generate instructions to cause the received batch to be unpacked according to the defined unpacking sequence, and to cause the set of labels to be applied according to a sequence in which the set of labels is printed.

In any of the preceding examples, units of the particular product in the received batch may be individually prepackaged in shippable packaging.

In any of the preceding examples, the plurality of orders awaiting fulfillment may be a plurality of preorders for the particular product, or a plurality of backorders for the particular product.

In some example aspects, the present disclosure describes a method. The method includes: receiving, from a scanner device, an identification of a received batch of a particular product, the identification including an identification of the particular product in the received batch and a quantity thereof in the received batch; querying a database of orders to identify a plurality of orders for the particular product awaiting fulfillment; determining that the quantity of the particular product in the received batch is less than or equal to a quantity of the particular product required to fulfill the plurality of orders for the particular product awaiting fulfillment. The method also includes: responsive to the determination that the quantity of the particular product in the received batch is less than or equal to the quantity required to fulfill the plurality of orders: rerouting the received batch to omit shelving and storing the received batch; and communicating instructions to a label printer to cause the label printer to print a set of shipping labels for application to the products of the received batch, wherein shipment of the labeled products fulfills a fulfillable number of the plurality of orders for the particular product awaiting fulfillment, and wherein a total quantity of the particular product required to fulfill the fulfillable number of the plurality of orders is equal to the quantity of the particular product in the received batch.

In any of the preceding examples, the method may include: responsive to the determination that the quantity of the particular product in the received batch is less than or equal to the quantity required to fulfill the plurality of orders, generating routing instructions to cause the received batch to be routed directly to a packing station or a shipping station

In any of the preceding examples, the method may include: communicating the routing instructions to an autonomous mobile robot assigned to convey the received batch, to change a target destination of the autonomous mobile robot to be the packing station or the shipping station.

In any of the preceding examples, the method may include: responsive to the determination that the quantity of the particular product in the received batch is less than or equal to the quantity required to fulfill the plurality of orders, generating routing instructions to cause the received batch to be shipped out directly without being routed to a packing station or a shipping station.

In any of the preceding examples, the method may include: updating the order database to indicate that the fulfillable number of the plurality of orders is fulfilled; where an inventory count of the particular product may be unchanged.

In any of the preceding examples, the method may include: identifying, from the identification of the received batch, at least two variants of the particular product in the received batch, and determining a respective position of each variant in a defined unpacking sequence for the received batch; determining an order sequence for the fulfillable number of the plurality of orders, based on matching a respective product variant required to fulfill each of the fulfillable number of the plurality of orders with the respective position of each variant in the defined unpacking sequence; and communicating instructions to the label printer to sequentially print the set of labels according to shipping information contained in each order in the order sequence.

In any of the preceding examples, the method may include: generating instructions to cause the received batch to be unpacked according to the defined unpacking sequence, and to cause the set of labels to be applied according to a sequence in which the set of labels is printed.

In any of the preceding examples, units of the particular product in the received batch may be individually prepackaged in shippable packaging.

In any of the preceding examples, the plurality of orders awaiting fulfillment may be a plurality of preorders for the particular product, or a plurality of backorders for the particular product.

In some example aspects, the present disclosure describes a computer readable medium having instructions encoded thereon. The instructions, when executed by a computing system, cause the computing system to: receive, from a scanner device, an identification of a received batch of a particular product, the identification including an identification of the particular product in the received batch and a quantity thereof in the received batch; query a database of orders to identify a plurality of orders for the particular product awaiting fulfillment; determine that the quantity of the particular product in the received batch is less than or equal to a quantity of the particular product required to fulfill the plurality of orders for the particular product awaiting fulfillment. The instructions further cause the computing system to: responsive to the determination that the quantity of the particular product in the received batch is less than or equal to the quantity required to fulfill the plurality of orders: reroute the received batch to omit shelving and storing the received batch; and communicate instructions to a label printer to cause the label printer to print a set of shipping labels for application to the products of the received batch, wherein shipment of the labeled products fulfills a fulfillable number of the plurality of orders for the particular product awaiting fulfillment, and wherein a total quantity of the particular product required to fulfill the fulfillable number of the plurality of orders is equal to the quantity of the particular product in the received batch.

In any of the preceding examples, the computer readable medium may include instructions to cause the system to perform any of the methods described above.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, in which examples described herein may be implemented;

FIG. 2 is an example homepage of an administrator, which may be accessed via the e-commerce platform of FIG. 1;

FIG. 3A is another block diagram of an example e-commerce platform, including a warehouse management engine, in which examples described herein may be implemented;

FIG. 3B is a block diagram illustrating an example implementation of a warehouse management engine in a fulfillment platform, in which examples described herein may be implemented;

FIG. 4 is illustrates example phases of a warehouse process;

FIG. 5 is a flowchart illustrating an example method for rerouting products at induct, in accordance with examples of the present disclosure; and

FIG. 6 illustrates an example of how an order sequence is determined based on the unpacking sequence, in accordance with examples of the present disclosure.

Similar reference numerals may have been used in different figures to denote similar components.

### DESCRIPTION OF EXAMPLE EMBODIMENTS

Examples of the present disclosure are described in the context of an e-commerce platform. However, it should be understood that the e-commerce platform described herein is only one possible example and is not intended to be limiting. It should be understood that the present disclosure may be implemented in other contexts, and is not necessarily limited to implementation in an e-commerce platform.

Examples of the present disclosure may be implemented in the context of any suitable fulfillment platform, which may or may not be part of an e-commerce platform. Examples of the present disclosure may also be implemented by a standalone warehouse management software (WMS) (e.g., provided as a software service).

### An Example E-Commerce Platform

Although integration with a commerce platform is not required, in some embodiments, the methods disclosed herein may be performed on or in association with a commerce platform such as an e-commerce platform. Therefore, an example of a commerce platform will be described.

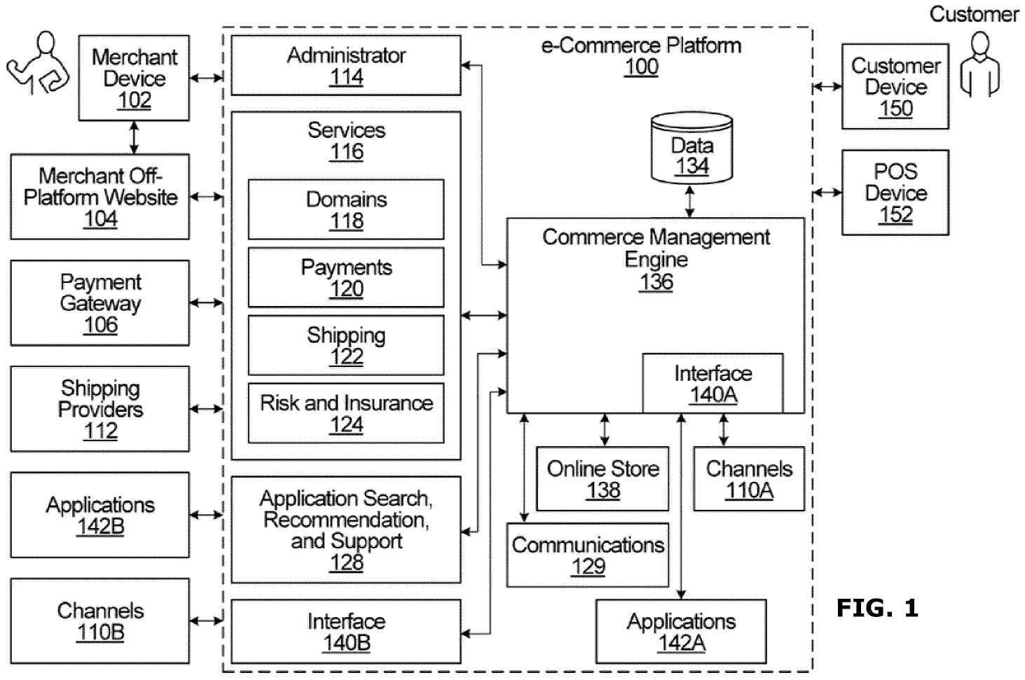

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant’s online e-commerce service offering through the e-commerce platform 100, where an online store 138 may refer either to a collection of storefronts supported by the e-commerce platform 100 (e.g., for one or a plurality of merchants) or to an individual merchant’s storefront (e.g., a merchant’s online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant’s storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B , channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store’s product information. It may be that themes can be further customized through a theme editor, a design interface that enables users to customize their website’s design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

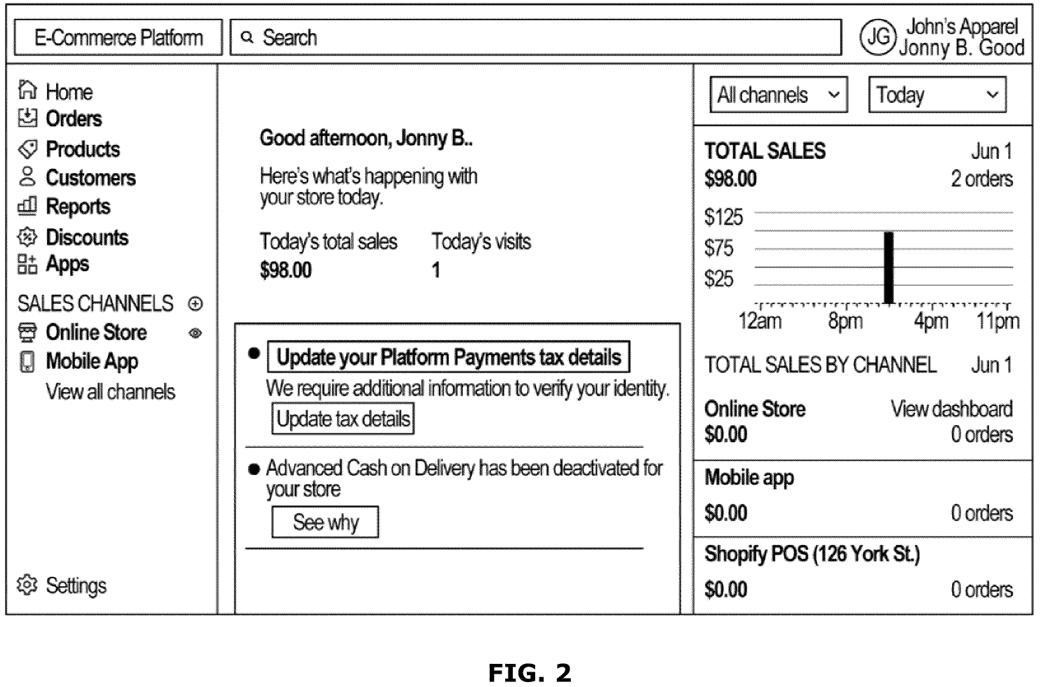

FIG. 2 depicts a non-limiting embodiment for a home page of an administrator 114. The administrator 114 may be referred to as an administrative console and/or an administrator console. The administrator 114 may show information about daily tasks, a store’s recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store’s 138 recent visit or order activity, updating the online store’s 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant’s business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant’s account; and settings applied to a merchant’s online store 138 and account. A merchant may use a search bar to find products, pages, or other information in their store.

More detailed information about commerce and visitors to a merchant’s online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store’s sales and engagement data. An activity feed in the home metrics section may be provided to illustrate an overview of the activity on the merchant’s account. For example, by clicking on a ‘view all recent activity’ dashboard button, the merchant may be able to see a longer feed of recent activity on their account. A home page may show notifications about the merchant’s online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant’s bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant’s online store 138, perform tasks through the administrator 114, implement new flows for a merchant through a user interface (e.g., that is surfaced through extensions / API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant’s products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant’s products through a number of different channels 110A-B such as, for example, the merchant’s online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer’s contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant’s use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren’t returned and remain in the customer’s hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the online shopping operations provided by the e-commerce platform 100 described above may support preorder and/or backorder sales. A preorder is an order that a customer makes for a product prior to release of the product. A backorder is an order for a product that may have been previously available but is currently out of stock.

The e-commerce platform 100 may perform operations enabling a preorder sale or backorder sale, similar to the operations for processing an order as described above (e.g., displaying a product page as part of the online store 138, using a shopping cart object to track a customer’s selection of a product to preorder or backorder, using a checkout object to receive customer information to complete the preorder or backorder, using the financial facility to complete payment of the preorder or backorder, etc.). However, the preorder or backorder may not be fulfilled at the time the preorder or backorder is made because the product is not available in inventory (e.g., not yet manufactured, insufficient number of units in stock, out of stock, etc.).

It is generally desirable (e.g., to ensure customer satisfaction) to fulfill preorders and backorders as soon as inventory becomes available. Both preorders and backorders may be referred to generally as orders awaiting inventory. Orders awaiting fulfillment may include any other type of orders that cannot be currently fulfilled and that should be fulfilled when inventory becomes available.

### Implementation in an E-Commerce Platform or Fulfillment Platform

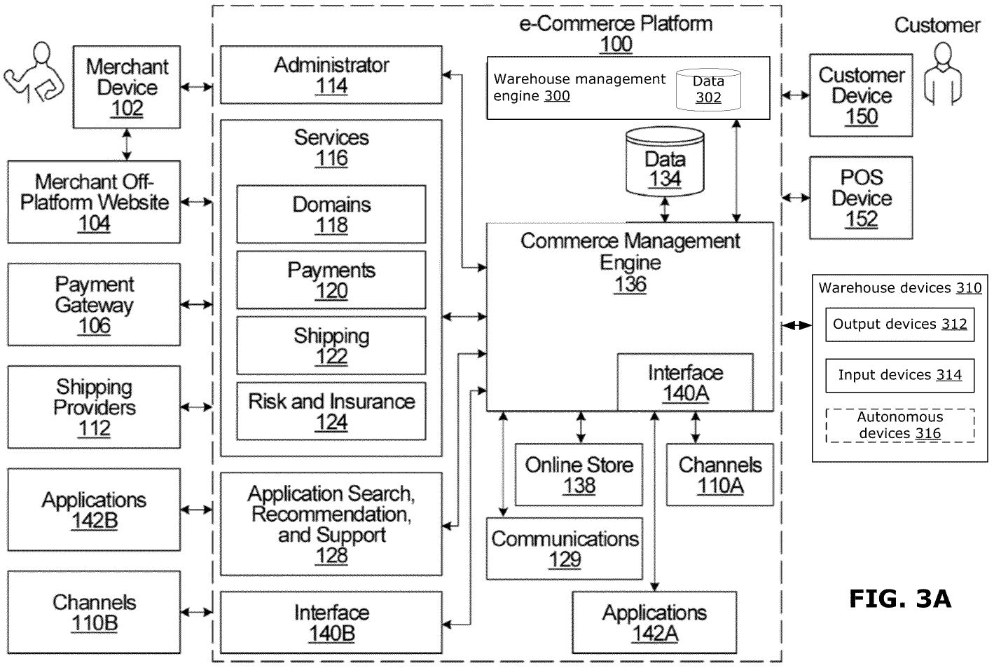

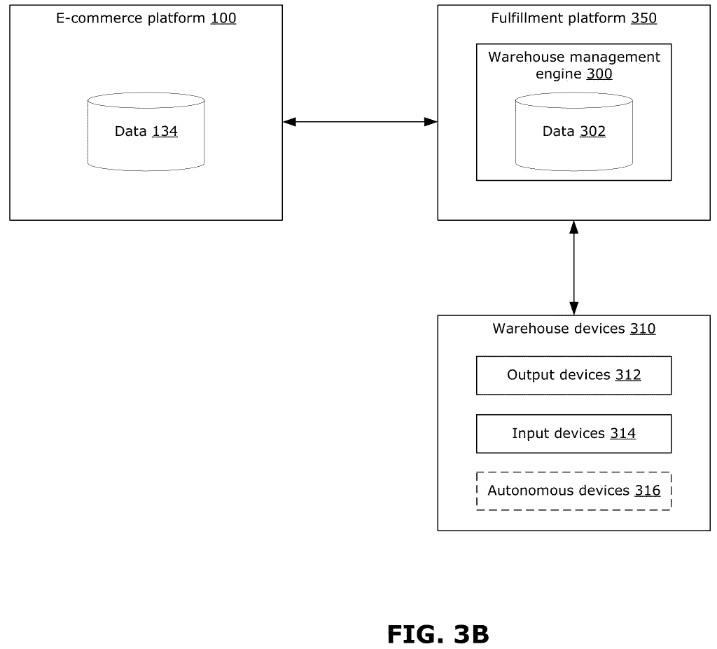

The functionality described herein may be used to provide improvements in efficiency of warehouse management. At least some aspects of the functionality described herein may be provided by the e-commerce platform 100, for example. FIG. 3A illustrates the e-commerce platform 100 of FIG. 1 but including a warehouse management engine 300. FIG. 3B illustrates an embodiment in which the warehouse management engine 300 is implemented in a fulfillment platform 350 that communicates with the e-commerce platform 100. The warehouse management engine 300 is an example of a computer-implemented system that implements at least some of the functionality described herein.

Although the warehouse management engine 300 is illustrated as a distinct component of the e-commerce platform 100 in FIG. 3A or of the fulfillment platform 350 in FIG. 3B, these are only examples. The warehouse management engine 300 could also or instead be provided by another component residing within or external to the e-commerce platform 100 or fulfillment platform 350. In various different implementations, the warehouse management engine 300 may be provided as a core function of the e-commerce platform 100 (e.g., as shown in FIG. 3A), as an application or service supported by the e-commerce platform 100, or as a component of the fulfillment platform 350 communicating with the e-commerce platform 100 (e.g., as shown in FIG. 3B). In some examples, the warehouse management engine 300 may be implemented as a stand-alone service to clients such as an owner of a warehouse. In some examples, the e-commerce platform 100 or the fulfillment platform 350 may be a cloud-based platform, and the functionality of the warehouse management engine 300 may be implemented using cloud-based computing resources (e.g., using a virtual pool of resources distributed over a plurality of physical computing systems).

The location of the warehouse management engine 300 may be implementation specific. It should be understood that the present disclosure is not limited to implementation of the warehouse management engine 300 in the e-commerce platform 100 or in the fulfillment platform 350.

As discussed in further detail below, the warehouse management engine 300 may implement at least some of the functionality described herein. Although the embodiments described below may be implemented in association with an e-commerce platform, such as (but not limited to) the e-commerce platform 100 of FIG. 1, the embodiments described below are not limited to e-commerce platforms. For example, the warehouse management engine 300 may be used to provide warehouse management services to an owner of a warehouse (who may or may not be a user of the e-commerce platform 100).

The warehouse management engine 300 may access data 134 managed by the e-commerce platform 100, such as customer data (e.g., shipping address) and order data (e.g., data about each order awaiting fulfillment, including product quantities and product codes for each order). The warehouse management engine 300 may additionally or alternatively maintain its own data 302. For example, the warehouse management engine 300 may manage inventory data, warehouse personnel data, warehouse space usage data, etc. in the data 302.

The warehouse management engine 300 also communicates with one or more warehouse devices 310 (e.g., via the e-commerce platform 100, via the fulfillment platform 350, or directly), which may include one or more output devices 312 (e.g., display(s), speaker(s), printer(s), etc.) for providing output to warehouse personnel, one or more input devices 314 (e.g., optical scanner(s), mechanical button(s), keyboard(s), mouse(s), microphone(s), etc.) for receiving input, and optionally one or more autonomous devices 316 (e.g., semi-autonomous or fully-autonomous mobile robot(s) or cart(s), semi-autonomous or fully-autonomous robotic arm(s), etc.).

Communications between the warehouse management engine 300 and the warehouse devices 310 may be over a wired or wireless network, which may be a local area network (LAN) for example. It should be appreciated that a large number of warehouse devices 310 (e.g., dozens of displays and optical scanners, and dozens of autonomous mobile robots if used) are typically required for normal warehouse operations in a typically-sized warehouse. The warehouse management engine 300 must communicate with these warehouse devices 310 to track movement of product through the warehouse phases, which adds to demands on network resources and possible network congestion.

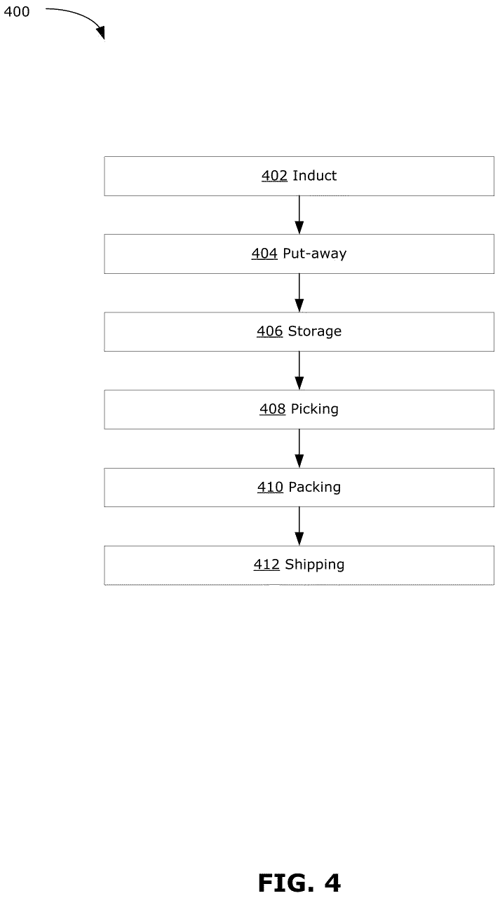

FIG. 4 illustrates warehouse phases in an example warehouse management process 400.

Products enter the warehouse management process 400 in the induct phase 402 (also referred to as the receiving phase). In the induct phase 402, products are received at the warehouse. The induct phase 402 typically occurs at an induct station (e.g., a receiving dock) of the warehouse. A certain quantity of products may be received in a batch (e.g., a certain number of units of a particular product are received in a pallet or a crate). A computer-readable code (e.g., a barcode) on the received products is scanned (e.g., using a handheld optical scanner), enabling the received products to be tracked by the warehouse management engine 300. Conventionally, the warehouse management engine 300 updates inventory data (e.g., the data 302) to increase inventory count corresponding to the quantity of received units of a product. As will be discussed further below, in accordance with examples of the present disclosure, updating the inventory data may be omitted in some embodiments.

Following the induct phase 402 is the put-away phase 404. In the put-away phase 404, products are moved (or “put away”) to their respective assigned locations in the warehouse. The warehouse management engine 300 may assign a location to store a particular product in the warehouse (e.g., depending on product size, weight, ease of access, etc.) and provide instructions (e.g., via an output device 312, such as a display) to a warehouse worker to move the product to the assigned location. The warehouse management engine 300 tracks movement of the particular product in the put-away phase 404, for example by requiring a warehouse worker to scan a barcode on the product when the product is placed on a cart, and scan a barcode on the product and/or assigned location when the product is moved from the cart to the assigned location. The warehouse management engine 300 may also require the warehouse worker to scan a badge or other identification, so that the warehouse management engine 300 can track which worker performed the put-away phase 404 (e.g., for traceability, accountability, management of personnel flow, etc.).

If the warehouse devices 310 include autonomous devices 316, such as an autonomous mobile robot, an autonomous mobile robot may be used in place of a cart to convey product in the put-away phase 404. The warehouse management engine 300 may communicate with the autonomous mobile robot, which has been assigned to convey the product, to provide the autonomous mobile robot with a target location in the warehouse to convey the product. The autonomous mobile robot typically executes path planning software to autonomously determine an optimal path to reach the target location, and such path planning may not be included in the functions provided by the warehouse management engine 300. The warehouse management engine 300 may also communicate with the autonomous mobile robot when the robot has reached the target location, so that the robot may be redeployed.

Following the put-away phase 404 is the storage phase 406. In the storage phase 406, products are shelved in their assigned location. The warehouse management engine 300 may track all products stored in the warehouse, to ensure efficient usage of physical resources (e.g., shelf space). Occasionally, the warehouse management engine 300 may determine that shelved products should be moved to a different assigned location, for example to make space for new inventory or to make use of newly vacated space in the warehouse. Thus, it should be understood that, even in the storage phase 406, the warehouse management engine 300 should continue to track and monitor the location and quantity of shelved products, with active management of product data. In some warehouse processes, the pack-away phase 404 and the storage phase 406 may be considered a single phase.

Following the storage phase 406 is the picking phase 408. In the picking phase 408, products are selected (or “picked”) from shelves to fulfill customer orders. For example, the warehouse management engine 300 accesses order data (e.g., data 134 maintained by the e-commerce platform 100) and identifies, from inventory data (e.g., data 302 maintained by the warehouse management engine 300), a particular product that should be picked to fulfill a particular customer order. The warehouse management engine 300 may provide instructions (e.g., via an output device 312, such as a display) to a warehouse worker to move the required quantity of the particular product from the shelves to the packing station. The warehouse management engine 300 tracks movement of the particular product in the picking phase 408, for example by requiring a warehouse worker to scan a barcode on the product when the product is picked from the shelf and placed on a cart. The warehouse management engine 300 may also require the warehouse worker to scan a badge or other identification, so that the warehouse management engine 300 can track which worker performed the picking phase 408 (e.g., for traceability, accountability, management of personnel flow, etc.). Conventionally, the warehouse management engine 300 updates inventory data (e.g., the data 302) to decrease inventory count corresponding to the quantity of units of the particular product that has been picked.

If the warehouse devices 310 include autonomous devices 316, such as an autonomous mobile robot, the autonomous mobile robot may be used in place of a cart to convey product in the picking phase 408. The warehouse management engine 300 may communicate with the autonomous mobile robot to provide the autonomous mobile robot with the location of the particular product to be picked, and (after the picked product has been placed on the robot and scanned) to thereafter direct the robot to convey the product to the packing station. The warehouse management engine 300 may also communicate with the autonomous mobile robot when the robot has reached the packing station and has been unloaded, so that the robot may be redeployed.

Following the picking phase 408 is the packing phase 410. In the packing phase 410, picked products are packed to be shipped out. The packing phase 410 typically occurs at a packing station of the warehouse. The warehouse management engine 300 may provide packing instructions (e.g., via an output device 312, such as a display) to a warehouse worker. The warehouse management engine 300 may also communicate with a printer, for example, to print a shipping label. The warehouse management engine 300 tracks movement of the particular product in the packing phase 410, for example by requiring a warehouse worker to scan a barcode on the product when the product is placed in a package. Further, the warehouse management engine 300 may also require the warehouse worker to scan a badge or other identification, so that the warehouse management engine 300 can track which worker performed the packing phase 410 (e.g., for traceability, accountability, management of personnel flow, etc.).

Finally, following the packing phase 410 is the shipping phase 412. In the shipping phase 412, packages are loaded on delivery vehicles and delivered to customers. The warehouse management engine 300 may track packages loaded onto delivery vehicles (e.g., by requiring a warehouse worker to scan a barcode on a package when a package is loaded onto a vehicle). Delivery of packages to customers may not be included in the functions performed by the warehouse management engine 300. For example, the warehouse management engine 300 may hand over responsibility for tracking delivery of the package to a delivery management engine (which may be part of the e-commerce platform 100 or fulfillment platform 350, or may be part of a separate carrier system).

As will be appreciated, significant computer resources are required to track products through the phases of the warehouse process 400. For example, the warehouse management engine 300 requires a product barcode to be scanned at each step of each warehouse phase, and this data is updated by the warehouse management engine 300 to ensure products are properly accounted for throughout the warehouse process 400. The warehouse management engine 300 also requires warehouse workers to scan their identification at each warehouse phase, for reasons of accountability and management of personnel. If autonomous mobile robots are used in the warehouse, the warehouse management engine 300 also has to communicate target locations for each robot and track their usage. All of this generates large amounts of data that frequently require updating throughout the warehouse process 400. This requires usage of processing power, as well as memory resources of a computer system (e.g., the servers of the e-commerce platform 100 or fulfillment platform 350). Further, a large amount of communications must take place between the warehouse management engine 300 and input or output devices 312, 314, which results in usage of network communication resources.

The example systems and methods disclosed herein enable at least the put-away phase 404, storage phase 406 and picking phase 408 to be bypassed in the unique scenario where an entire received batch (e.g., entire pallet or entire crate) of a particular product all needs to be shipped out immediately to fulfill orders awaiting fulfillment (e.g., to fulfill preorders or backorders). In some examples, the received batch of product may be rerouted directly to the packing phase 410, or may be rerouted directly to the shipping phase 412. In some examples, the received batch of product may be labeled for shipping and shipped out directly from induct, thus bypassing all or almost all phases of the conventional warehouse process 400. This results in significant savings in terms of computer resources, and network communication resources, not to mention human resources, storage resources, and autonomous vehicle resources.

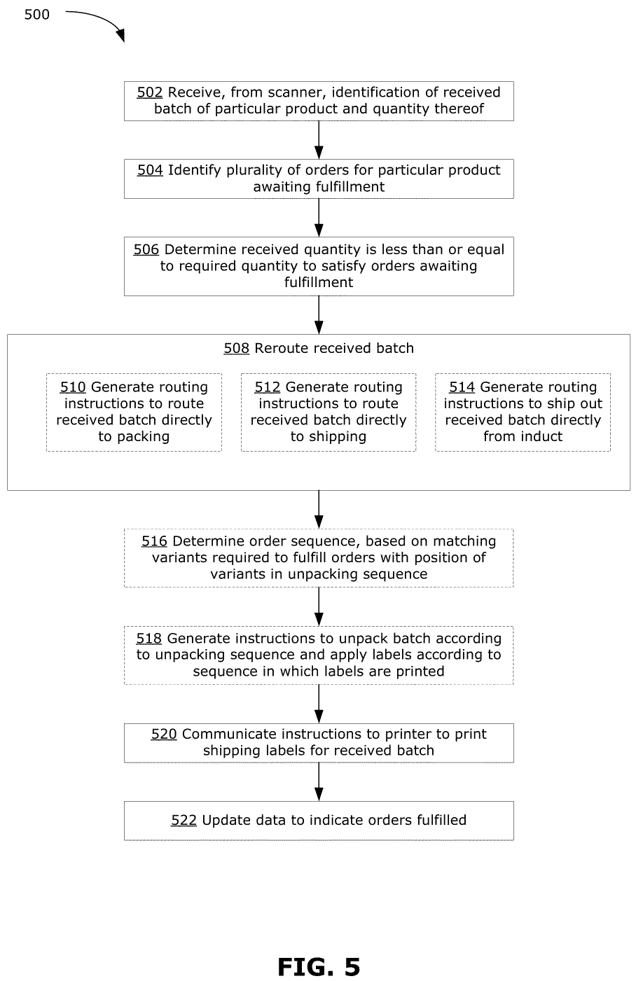

FIG. 5 is a flowchart illustrating an example method 500 that may be performed by the warehouse management engine 300. For example, a computing system (e.g., a server, or a server cluster) implementing the e-commerce platform 100 or the fulfillment platform 350 (including the warehouse management engine 300) may include a processing unit (e.g., processor) that executes computer-readable instructions to perform the method 500.

The method 500 may start when a received batch of a particular product (e.g., a received pallet or a received crate) is received in the induct phase 402 (e.g., received at an induct station, which may be located at a receiving dock of the warehouse).

At an operation 502, an identification of a received batch of a particular product is received from an input device 312, such as a scanner device. For example, when a batch of the particular product (e.g., a pallet, a crate or a box of the product) is received at the induct station, a barcode or other computer-readable code on the batch may be scanned using an optical scanner. The scanner device may communicate the scanned data to the warehouse management engine 300. The received identification includes an identification of the particular product (e.g., a product code, such as a stock keeping unit (SKU)) and an indication of the quantity of the particular product (e.g., number of units of the product) in the received batch.

In some examples, the particular product may be available in two or more variants (e.g., different colors, different sizes, etc.), which may be identified in the received identification (e.g., different variants may be identified using different SKUs). The position of each variant in a defined unpacking sequence of the batch of product may be determined. For example, the received identification may indicate that a first variant is in a top layer of a received pallet and a second variant is in a bottom layer of the pallet. Then, according to the defined unpacking sequence for unpacking a pallet (e.g., warehouse workers may be trained to unpack a pallet layer-by-layer, thus unpacking the top layer first followed by the bottom layer), the warehouse management engine 300 may determine that the first variant would be in the first half of the unpacking sequence, and the second variant would be in the second half of the unpacking sequence.

At an operation 504, the warehouse management engine 300 identifies a plurality of orders for the particular product that are awaiting fulfillment. The orders awaiting fulfillment may include preorders for the product or backorders for the product, for example. The warehouse management engine 300 may, for example, query a database of orders (e.g., the data 134 maintained by the e-commerce platform 100), to identify the orders for the particular product that are awaiting fulfillment.

At an operation 506, it is determined that the received quantity of the particular product is less than or equal to a required quantity of product that is required to fulfill the orders awaiting fulfillment. The warehouse management engine 300 may determine that the entirety of the received batch should be used to fulfill at least a fulfillable number of the orders awaiting fulfillment. In particular, the total quantity of the particular product that is required to fulfill the fulfillable number of the orders awaiting fulfillment is equal to the quantity of the particular product in the received batch. It should be noted that the fulfillable number of orders is not necessarily equal to the number of units of the particular product in the received batch. For example, if some orders require multiple units of product, then fewer orders can be fulfilled by the received batch. In a special case where all orders awaiting fulfillment can be each be fulfilled using a single unit of product, then the fulfillable number of orders is equal to the quantity of product in the received batch. Further, if the orders awaiting fulfillment cannot all be fulfilled by the received batch, then the fulfillable number of orders is fewer than the total number of orders awaiting fulfillment.

For example, if the warehouse management engine 300 has identified (e.g., at the operation 504) that there are preorders for 120 units of the particular product and the received batch contains 100 units, then the warehouse management engine 300 may determine that the entirety of the received batch should be used to fulfill at least a fulfillable number of the preorders. If every preorder is for a single unit of the product, then 100 preorders can be fulfilled by the 100 units in the received batch. If some preorders require more than a single unit of the product, then fewer than 100 preorders can be fulfilled by the 100 units in the received batch.

If the fulfillable number of orders is fewer than the total number of orders awaiting fulfillment, the warehouse management engine 300 may use various techniques to select which of the orders should be fulfilled by the received batch. For example, the warehouse management engine 300 may identify the oldest orders (i.e., the orders that have been awaiting fulfillment for the longest period of time) as the orders to be fulfilled by the received batch. In another example, the warehouse management engine 300 may identify the orders requiring the largest quantity of product (i.e., the orders that need the greater number of products) as the orders to be fulfilled by the received batch. In another example, the warehouse management engine 300 may identify the orders associated with high priority customer accounts (e.g., as identified from the order data) as the orders to be fulfilled by the received batch. Other approaches may be used.

In examples where the particular product is available in two or more variants, and different variants are in the received batch, the warehouse management engine 300 may determine that the received quantity of each variant is all required by respective orders for that variant. In other words, the warehouse management engine 300 may determine that the entirety of the received batch should be used to fulfill the orders, on the basis that the quantity of each variant that is in the received batch is less than or equal to the required quantity of that variant required to fulfill orders for that variant.

At an operation 508, the received batch is rerouted. The warehouse management engine 300 may generate instructions for a warehouse worker in the induct station (e.g., to be outputted via a display at the induct station, or outputted via a handheld display carried by the worker) to indicate that the received batch is to be rerouted. This may alert the worker that the received batch is not to be unpacked and inspected as usual. Rerouting the received batch of the particular product may mean that all of the product in the received batch is directly labeled for shipping, without directing the product to be shelved or stored in the warehouse (thus omitting at least the put-away phase 404, storage phase 406 and picking phase 408).

Carrying out the operation 508 may include carrying out any one of the operations 510, 512 or 514, described further below.

At an operation 510, the warehouse management engine 300 may generate instructions to route the received batch of product directly to the packing phase 410 (e.g., to a packing station in the warehouse), omitting the put-away phase 404, storage phase 406 and picking phase 408. For example, the warehouse management engine 300 may generate instructions to be outputted to a warehouse worker in the induct station (e.g., via a display at the induct station, outputted via a handheld display carried by the worker, or outputted via a display mounted on a cart that is used for moving the received batch), where the instructions instruct the worker to move the received batch of products directly to the packing station.

In examples where autonomous devices 316, such as autonomous mobile robots, are used to convey product in the warehouse, the warehouse management engine 300 may communicate the routing instructions to an autonomous mobile robot assigned to convey the received batch. The routing instructions communicated to the robot may provide the robot with a target destination that is the packing station (instead of an assigned shelving location in the warehouse).

The operation 510 may be performed in cases where the product requires packaging before it can be shipped. For example, the product in the received batch may not be individually packed in shippable packaging. In another example, individual units of the product may need to be packed together into a single package (e.g., to fulfill an order for multiple units of the product).

Alternatively, at an operation 512, the warehouse management engine 300 may generate instructions to route the received batch of product directly to the shipping phase 412 (e.g., to a shipping station in the warehouse), omitting the put-away phase 404, storage phase 406, picking phase 408 and packing phase 410. For example, the warehouse management engine 300 may generate instructions to be outputted to a warehouse worker in the induct station (e.g., via a display at the induct station, outputted via a handheld display carried by the worker, or outputted via a display mounted on a cart that is used for moving the received batch), where the instructions instruct the worker to move the received batch of products directly to the shipping station.

In examples where autonomous devices 316, such as autonomous mobile robots, are used to convey product in the warehouse, the warehouse management engine 300 may communicate the routing instructions to an autonomous mobile robot assigned to convey the received batch. The routing instructions communicated to the robot may provide the robot with a target destination that is the shipping station (instead of an assigned shelving location in the warehouse).

The operation 512 may be performed in cases where the product does not require packaging before it can be shipped (e.g., a shipping label can be applied directly onto the product packaging). For example, individual units of the product in the received batch may already be prepacked in shippable packaging. In another example, every order to be fulfilled by the received batch of product can be fulfilled using individually packed units (e.g., every order is an order for a single unit of product, or an order for multiple units can be fulfilled by shipping the units in individual packages).

Alternatively, at an operation 514, the warehouse management engine 300 may generate instructions to reroute the received batch such that the received batch is shipped out directly from induct, thus bypassing the entire warehouse process. The need to move and track the received batch of product may thus be entirely avoided, thus greatly reducing the usage of personnel, the usage of computer resources to generate and maintain data to track the product, and the usage of carts or autonomous mobile robots to convey product, among other savings.

For example, the warehouse management engine 300 may generate instructions to be outputted to a warehouse worker in the induct station (e.g., via a display at the induct station, or outputted via a handheld display carried by the worker), where the instructions instruct the worker to directly unpack the received batch of product and apply shipping labels.

The operation 514 may be performed if the warehouse is configured such that products can be shipped out from the induct station (e.g., the induct station and the shipping station are both located at the receiving and loading dock(s) of the warehouse). The warehouse management engine 300 may be configured to enable shipping out of product from the induct station (e.g., a warehouse manager may enable this option, depending on the physical setup of the warehouse). The operation 514 may be performed if the requirements for performing the operation 512 are also satisfied (e.g., the product is received already in shippable packaging).

The warehouse management engine 300 may perform the operation 508 using any one of the operations 510, 512 or 514. The warehouse management engine 300 may determine whether the received batch should be routed directly to packing (e.g., using the operation 510), routed directly to shipping (e.g., using the operation 512), or shipped out directly from induct (e.g., using the operation 514) on a case-by-case basis.

For example, the warehouse management engine 300 may determine (e.g., from the product specification defined in the data 134 maintained by the e-commerce platform 100) that each unit of product is already prepackaged in shippable packaging when received at induct, and the operation 512 may be performed. The warehouse management engine 300 may be configured to enable shipping of product directly from the induct station (e.g., depending on the physical setup of the warehouse) and may perform the operation 514 instead of the operation 512. If the warehouse management engine 300 instead determines (e.g., from the product specification) that the product is not already prepackaged in shippable packaging, the operation 510 may be performed.

Regardless of how the operation 508 is performed, following the operation 508, optional operation 516 may be performed.

Optional operations 516 and 518 may be performed if the received batch of products include two or more product variants, which are all required to fulfill orders for the respective variants.

At the optional operation 516, an order sequence is determined, based on matching variants required to fulfill the identified orders (e.g., identified at the operation 504) with the position of the respective variants in the unpacking sequence. For example, as discussed previously, the identification received at the operation 502 may indicate the two or more product variants in the received batch, and the order of the variants in the unpacking sequence may be known.

The orders identified at the operation 504 may each indicate a respective product variant and a respective shipping address. The product variant indicated in each order may be matched with the corresponding location of the variant in the unpacking sequence. The order sequence is then determined such that the variant indicated by a given order in a given position in the order sequence matches the variant that is at the same given position in the unpacking sequence.

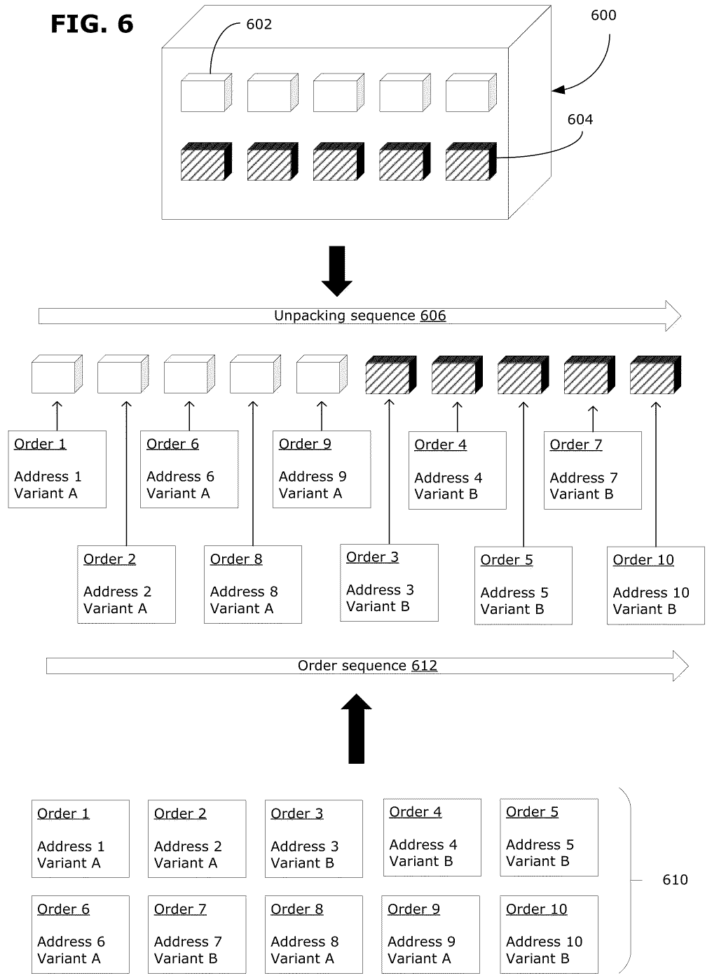

FIG. 6 is a diagram illustrating an example of how an order sequence is determined, based on matching required variants with the position of variants in the unpacking sequence.

In this simple example, a received batch 600 of a particular product contains five units of first variant 602 (referred to as variant A, and indicated in white) of the product in a top layer and five units of a second variant 604 (referred to as variant B, and indicated using hatching) of the product in a bottom layer. The warehouse management engine 300 identifies the two variants 602, 604 and their respective layers using identification information scanned from a barcode on the received batch 600, for example.

In this example, the received batch 600 is received in a crate containing multiple layers of product. The unpacking procedure that is defined for this type of crate is to unpack the top layer of product first, followed by subsequence layers until the final bottom layer. This unpacking procedure may be predefined and known. Accordingly, the warehouse management engine 300 determines that unpacking sequence 606 results in variant A 602 being unpacked first, followed by the variant B 604.

The warehouse management engine 300 also identifies a plurality of orders 610 for the particular product awaiting fulfillment. In this example, there are ten orders 610 identified (namely, orders 1-10), and each order indicates a respective shipping information (e.g., respective address 1-10) and a respective product variant. The warehouse management engine 300 arranges the orders 610 in an order sequence 612, such that orders 1, 2, 6, 8 and 9, which require variant A, are positioned in the order sequence 612 in positions that match the positions of variant A in the unpacking sequence 606. Similarly, orders 3, 4, 5, 7 and 10, which require variant B, are positioned in the order sequence 612 in positions that match the positions of variant B in the unpacking sequence 606.

Accordingly, if the received batch 600 is correctly unpacked according to the unpacking sequence 606 and if labels are sequentially printed according to the shipping information in the order sequence 612, labels can be applied to each unit of product as it is unpacked according to the sequence in which the labels are printed.

Reference is again made to FIG. 5. Optional operation 518 may follow optional operation 516. At the optional operation 518, the warehouse management engine 300 generates instructions (e.g., to be outputted via a display to a warehouse worker) to unpack the received batch of the particular product according to the defined unpacking sequence. The warehouse management engine 300 may also generate instructions to apply labels according to the sequence in which the labels are printed from a label printer. In some examples, warehouse workers may already be trained on the unpacking procedure and labeling procedure, such that the received batch of the particular product will be unpacked according to the defined unpacking sequence and will be labeled according to the sequence in which the labels are printed, without requiring explicit instructions. In such examples, operation 518 may be omitted.

At an operation 520, the warehouse management engine 300 communicates instructions to a label printer (which is an output device 312) to print shipping labels for the received batch of the particular product. The printed shipping labels are to be applied to the received batch of product, so that the received batch can be shipped out to fulfill the orders identified at the operation 504 described above.

If an order sequence has been determined at the optional operation 516, the sequence in which the labels are printed should match the shipping information in the determined order sequence.

At an operation 522, order data (e.g., in the data 134 maintained by the e-commerce platform 100) is updated by the warehouse management engine 300 to indicate that the orders identified at the operation 504 have been fulfilled. In some examples, updating this order data may not require the warehouse management engine 300 to update its own inventory data (e.g., in the data 302 maintained by the warehouse management engine 300) to reflect a corresponding decrease in inventory, because the received batch of product bypassed the storage phase 406 and was not entered into the inventory data. In other words, the inventory count of the particular product may be unchanged through the entire method 500. This may further help to reduce the use of computer resources (e.g., memory resource and processing power), because the amount of data that needs to be generated and updated is reduced.

In general, the warehouse management engine 300 may generate routing instructions such that as many phases of the warehouse process are bypassed as possible, to help maximize savings in computing resources (e.g., by avoiding the need to generate and manage data to track movement of the received batch of product in the warehouse, by reducing the amount of communications with warehouse devices 310, etc.), as well as human resources and storage resources (e.g., by avoiding the need to move the received batch of product to shelving in the warehouse and subsequent picking of the product).

In a special case where the entire received batch of product is required to fulfill a single order awaiting fulfillment (e.g., a received batch of 100 units of a particular product is all required to fulfill a single order for 100 or more units of that particular product), the warehouse management engine 300 may generate instructions that omit unpacking of the received batch. Instead, a shipping label may be printed and applied to the entire received batch of product, and the entire received batch may be shipped out as-is (e.g., using the pallet or crate in which the batch was received) without any unpacking. Thus, all phases of the typical warehouse process may be bypassed. The warehouse management engine 300 may update the order data to indicate the single order was fulfilled, without making any updates to the inventory data.

In various examples, the present disclosure describes systems and methods that enable bypassing of standard warehouse procedures, such as bypassing the put-away phase, storage phase and picking phases. Unlike conventional approaches, the present disclosure provides flexibility in warehouse management, to achieve significant savings in warehouse resources, including computer resources and network communication resources as well as human resources and storage resources.

In particular, the computer resources (e.g., processing power, memory resources, etc.) and network communication resources (e.g., bandwidth) that would otherwise be required to track product, track workers and generate worker instructions through the put-away, storage and picking phases, may be saved. If autonomous mobile robots are used to convey products in the warehouse, the computer resources and network communication resources that would otherwise be required to communicate with these robots through the put-away, storage and picking phases, may also be saved.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A system comprising:
a processing unit configured to execute instructions to cause the system to:
receive, from a scanner device, an identification of a received batch of a particular product, the identification including an identification of the particular product in the received batch and a quantity thereof in the received batch;
query a database of orders to identify a plurality of orders for the particular product awaiting fulfillment;
determine that the quantity of the particular product in the received batch is less than or equal to a quantity of the particular product required to fulfill the plurality of orders for the particular product awaiting fulfillment; and
responsive to the determination that the quantity of the particular product in the received batch is less than or equal to the quantity required to fulfill the plurality of orders:
reroute the received batch to omit shelving and storing the received batch; and
communicate instructions to a label printer to cause the label printer to print a set of shipping labels for application to the products of the received batch, wherein shipment of the labeled products fulfills a fulfillable number of the plurality of orders for the particular product awaiting fulfillment, and wherein a total quantity of the particular product required to fulfill the fulfillable number of the plurality of orders is equal to the quantity of the particular product in the received batch.

2. The system of claim 1, wherein the processing unit is further configured to execute instructions to cause the system to:
responsive to the determination that the quantity of the particular product in the received batch is less than or equal to the quantity required to fulfill the plurality of orders, generate routing instructions to cause the received batch to be routed directly to a packing station or a shipping station.

3. The system of claim 2, wherein the processing unit is further configured to execute instructions to cause the system to:
communicate the routing instructions to an autonomous mobile robot assigned to convey the received batch, to change a target destination of the autonomous mobile robot to be the packing station or the shipping station.

4. The system of claim 1, wherein the processing unit is further configured to execute instructions to cause the system to:
responsive to the determination that the quantity of the particular product in the received batch is less than or equal to the quantity required to fulfill the plurality of orders, generate routing instructions to cause the received batch to be shipped out directly without being routed to a packing station or a shipping station.

5. The system of claim 1, wherein the processing unit is further configured to execute instructions to cause the system to:
update the order database to indicate that the fulfillable number of the plurality of orders is fulfilled; and
wherein an inventory count of the particular product is unchanged.

6. The system of claim 1, wherein the processing unit is further configured to execute instructions to cause the system to:
identify, from the identification of the received batch, at least two variants of the particular product in the received batch, and determine a respective position of each variant in a defined unpacking sequence for the received batch;
determine an order sequence for the fulfillable number of the plurality of orders, based on matching a respective product variant required to fulfill each of the fulfillable number of the plurality of orders with the respective position of each variant in the defined unpacking sequence; and
communicate instructions to the label printer to sequentially print the set of labels according to shipping information contained in each order in the order sequence.

7. The system of claim 6, wherein the processing unit is further configured to execute instructions to cause the system to:
generate instructions to cause the received batch to be unpacked according to the defined unpacking sequence, and to cause the set of labels to be applied according to a sequence in which the set of labels is printed.

8. The system of claim 1, wherein units of the particular product in the received batch are individually prepackaged in shippable packaging.

9. The system of claim 1, wherein the plurality of orders awaiting fulfillment is a plurality of preorders for the particular product, or a plurality of backorders for the particular product.

10. A method, comprising:
receiving, from a scanner device, an identification of a received batch of a particular product, the identification including an identification of the particular product in the received batch and a quantity thereof in the received batch;
querying a database of orders to identify a plurality of orders for the particular product awaiting fulfillment;
determining that the quantity of the particular product in the received batch is less than or equal to a quantity of the particular product required to fulfill the plurality of orders for the particular product awaiting fulfillment; and
responsive to the determination that the quantity of the particular product in the received batch is less than or equal to the quantity required to fulfill the plurality of orders:
rerouting the received batch to omit shelving and storing the received batch; and
communicating instructions to a label printer to cause the label printer to print a set of shipping labels for application to the products of the received batch, wherein shipment of the labeled products fulfills a fulfillable number of the plurality of orders for the particular product awaiting fulfillment, and wherein a total quantity of the particular product required to fulfill the fulfillable number of the plurality of orders is equal to the quantity of the particular product in the received batch.

11. The method of claim 10, further comprising:
responsive to the determination that the quantity of the particular product in the received batch is less than or equal to the quantity required to fulfill the plurality of orders, generating routing instructions to cause the received batch to be routed directly to a packing station or a shipping station.

12. The method of claim 11, further comprising:
communicating the routing instructions to an autonomous mobile robot assigned to convey the received batch, to change a target destination of the autonomous mobile robot to be the packing station or the shipping station.

13. The method of claim 10, further comprising:
responsive to the determination that the quantity of the particular product in the received batch is less than or equal to the quantity required to fulfill the plurality of orders, generating routing instructions to cause the received batch to be shipped out directly without being routed to a packing station or a shipping station.

14. The method of claim 10, further comprising:
updating the order database to indicate that the fulfillable number of the plurality of orders is fulfilled;
wherein an inventory count of the particular product is unchanged.

15. The method of claim 10, further comprising:
identifying, from the identification of the received batch, at least two variants of the particular product in the received batch, and determining a respective position of each variant in a defined unpacking sequence for the received batch;
determining an order sequence for the fulfillable number of the plurality of orders, based on matching a respective product variant required to fulfill each of the fulfillable number of the plurality of orders with the respective position of each variant in the defined unpacking sequence; and
communicating instructions to the label printer to sequentially print the set of labels according to shipping information contained in each order in the order sequence.

16. The method of claim 15, further comprising:
generating instructions to cause the received batch to be unpacked according to the defined unpacking sequence, and to cause the set of labels to be applied according to a sequence in which the set of labels is printed.

17. The method of claim 10, wherein units of the particular product in the received batch are individually prepackaged in shippable packaging.

18. The method of claim 10, wherein the plurality of orders awaiting fulfillment is a plurality of preorders for the particular product, or a plurality of backorders for the particular product.

19. A computer readable medium having instructions encoded thereon, wherein the instructions, when executed by a computing system, cause the computing system to:
receive, from a scanner device, an identification of a received batch of a particular product, the identification including an identification of the particular product in the received batch and a quantity thereof in the received batch;
query a database of orders to identify a plurality of orders for the particular product awaiting fulfillment;
determine that the quantity of the particular product in the received batch is less than or equal to a quantity of the particular product required to fulfill the plurality of orders for the particular product awaiting fulfillment; and
responsive to the determination that the quantity of the particular product in the received batch is less than or equal to the quantity required to fulfill the plurality of orders:
reroute the received batch to omit shelving and storing the received batch; and
communicate instructions to a label printer to cause the label printer to print a set of shipping labels for application to the products of the received batch, wherein shipment of the labeled products fulfills a fulfillable number of the plurality of orders for the particular product awaiting fulfillment, and wherein a total quantity of the particular product required to fulfill the fulfillable number of the plurality of orders is equal to the quantity of the particular product in the received batch.

20. The computer readable medium of claim 19, wherein the instructions further cause the system to:
responsive to the determination that the quantity of the particular product in the received batch is less than or equal to the quantity required to fulfill the plurality of orders, generate routing instructions to cause the received batch to be shipped out directly without being routed to a packing station or a shipping station.
